(19) United States
(12) Patent Application Publication
(10) Pub. No.: US 2009/0282028 A1
(43) Pub. Date: Nov. 12, 2009

(54) User Interface and Method for Web Browsing based on Topical Relatedness of Domain Names

(76) Inventors: Michael Subotin, Greenbelt, MD (US); Alan Sullivan, Leesburg, VA (US)

Correspondence Address: POTOMAC PATENT GROUP PLLC, P. O. BOX 270, FREDERICKSBURG, VA, 22404, US

(21) Appl. No.: 12/434,627

(22) Filed: May 2, 2009

Related U.S. Application Data
(60) Provisional application No. 61/192,942, filed on Sep. 23, 2008.

(51) Int. Cl. G06F 17/30

(52) U.S. Cl. 707/5; 707/E17.109; 707/100; 707/E17.044

(57) ABSTRACT

Systems, computer software and methods for searching plural domain names based on domain name system queries are described. The method includes receiving as input a domain name, searching a database for identifying scores measuring relatedness of the input domain name and other domain names of the plural domain names, retrieving related domain names with the highest relatedness scores, and associating the input domain name and the related domain names. The relatedness scores are calculated based on the domain name system queries of users.

### RELATED APPLICATION

This application is related to, and claims priority from, U.S. Provisional Patent Application Ser. No. 61/192,942, filed on Sep. 23, 2008, entitled “Method and System for Determining Topical Relatedness of Domain Names” to M. Subotin and A. Sullivan, the entire disclosure of which is incorporated here by reference.

### TECHNICAL FIELD

The present invention generally relates to systems, computer software and methods and, more particularly, to mechanisms and techniques for web browsing based on the topical relatedness of domain names.

### BACKGROUND

During the past several years, interest in data available on the Internet and Internet services has dramatically increased, in part due to the affordability of access to the Internet and in part due to the ease of obtaining fast and reliable information. Moreover, Internet users have come to realize that the amount of data that is available on the Internet is phenomenal. Various search engines are available to aid Internet users to search for desired information. Conventional search engines (e.g., those provided by Yahoo, Google, etc.) provide the user with an input box into which the user must enter keywords related to the desired information. FIG. 1 illustrates such a conventional search process, e.g., with one or more keyword(s) being input in step 100. The keyword(s) may refer, for example, to a product that the user is interested in. The keyword(s) are received by the search engine in step 110. A component of the search engine determines, in step 120, which web sites or web pages are relevant to the keyword(s) which were entered by the user. This determination is made in part by matching the keyword(s) with the content of the web sites. More specifically, the keyword input(s) entered by the user is found in the information available on, or associated with, the web page such that the web page is determined to be relevant by the search engine. A ranked list of all of the web sites that were matched to the keyword(s) is provided, in step 130, to the user, e.g., as a list of links or the like.

With this approach pages from a domain are unlikely to be displayed to the user unless user's query includes its domain name or other words included in its content verbatim. In contrast, in many scenarios the user many be interested in finding web pages related to the content of a particular domain but not belonging to the domain itself. This may be the case, for example, when a user who knows one online store specializing in a particular area is looking to find other stores which sell similar products for purposes of price comparison.

Additionally, there is an opportunity to supply ads which are embedded into the information that a user is looking for, and the advertisement industry is repositioning itself to occupy this new advertising field. More and more ads are being placed on most of the web pages visited by Internet users with the expectation that some of the users will visit those ads and at least explore, if not buy, the goods or services featured in the ads. Various companies have started to specialize in tracking consumer/client behavior such that more targeted ads are placed on the visited web pages. It is known that it is not efficient to advertise goods or services on web pages that are not related to those goods or services.

Accordingly, it would be desirable to provide systems and methods for generating and updating information about relatedness of Internet domains and web pages.

### SUMMARY

According to one exemplary embodiment, there is a method for searching plural domain names based on domain name system queries. The method includes receiving as input a domain name; searching a database for identifying scores measuring relatedness of the input domain name and other domain names of the plural domain names; retrieving related domain names with the highest relatedness scores; and associating the input domain name and the related domain names, wherein the relatedness scores are calculated based on the domain name system queries of users.

According to another exemplary embodiment, there is a computer readable medium including computer executable instructions, where the instructions, when executed, implement a method for searching plural domain names based on domain names queries. The method includes providing a system comprising distinct software modules, wherein the distinct software modules comprise a relatedness score module and a ranking module; receiving as input a domain name; searching a database for identifying scores measuring relatedness of the input domain name and other domain names of the plural domain names; retrieving related domain names with the highest relatedness scores; and associating the input domain name and the related domain names, wherein the relatedness scores are calculated based on the domain name system queries of users.

According to still another exemplary embodiment, there is a graphical user interface for searching plural domain names based on domain name system queries. The graphical user interface includes means for receiving, as input, a domain name; means for searching a database for identifying scores measuring relatedness of the input domain name and other domain names of the plural domain names; means for retrieving related domain names with the highest relatedness scores; and means for associating the input domain name and the related domain names, wherein the relatedness scores are calculated based on the domain name system queries of users.

According to still another exemplary embodiment, there is a computing system for searching plural domain names based on domain names queries. The computing system includes an input/output interface configured to receive as input a domain name and a processor connected to the input/output interface. The processor is configured to search a database for identifying scores measuring relatedness of the input domain name and other domain names of the plural domain names, retrieve related domain names with the highest relatedness scores, and associate the input domain name and the related domain names. The relatedness scores are calculated based on the domain name system queries of users.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram illustrating how a traditional search engine determines a web page to be presented to a user;

FIG. 2 is an exemplary graphical user interface that a client may use in a novel browser according to an exemplary embodiment;

FIG. 3 is an exemplary screenshot of the novel graphical user interface of FIG. 2 according to an exemplary embodiment;

FIG. 4 illustrates various categories that may be displayed by a graphical user interface according to an exemplary embodiment;

FIG. 5 further illustrates various categories that may be displayed by the graphical user interface of FIG. 4 according to an exemplary embodiment;

FIG. 6 illustrates a screen that may be displayed by the graphical user interface according to an exemplary embodiment;

FIG. 7 illustrates data associated with a domain name that is displayed by a conventional browser;

FIG. 8 illustrates a tree path of requested domain names according to an exemplary embodiment;

FIG. 9 is a schematic diagram of a computer based system in which a client accesses the Internet via an Internet Service Provider and an independent server may provide various services to the client according to an exemplary embodiment;

FIG. 10 illustrates an example of a tree path of three domain names and associated relatedness measures according to an exemplary embodiment;

FIG. 11 illustrates a result of a search based on domain name queries that may be provided by the graphical user interface according to an exemplary embodiment;

FIG. 12 is a flow chart illustrating steps of a method for searching plural domain names based on relatedness scores according to an exemplary embodiment;

FIG. 13 illustrates data that may be provided by the graphical user interface in response to an input domain name according to an exemplary embodiment;

FIG. 14 illustrates how the data provided by the graphical user interface of FIG. 13 may be presented to a user according to an exemplary embodiment;

FIG. 15 is a flowchart illustrating steps for searching plural domain names based on an input domain name according to an exemplary embodiment;

FIG. 16 is a schematic diagram of a computing device that generates the graphical user interface according to an exemplary embodiment; and

FIG. 17 is a schematic diagram of specific modules for performing the steps shown in FIGS. 12 and 15 according an exemplary embodiment.

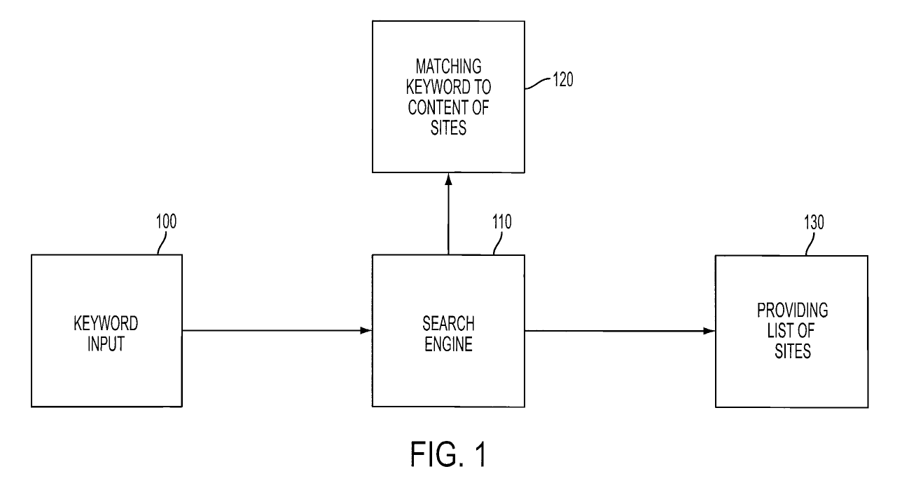

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of Internet based systems having, among other things, DNS functionality. However, the embodiments to be discussed next are not limited to these systems but may be applied to other existing data systems.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

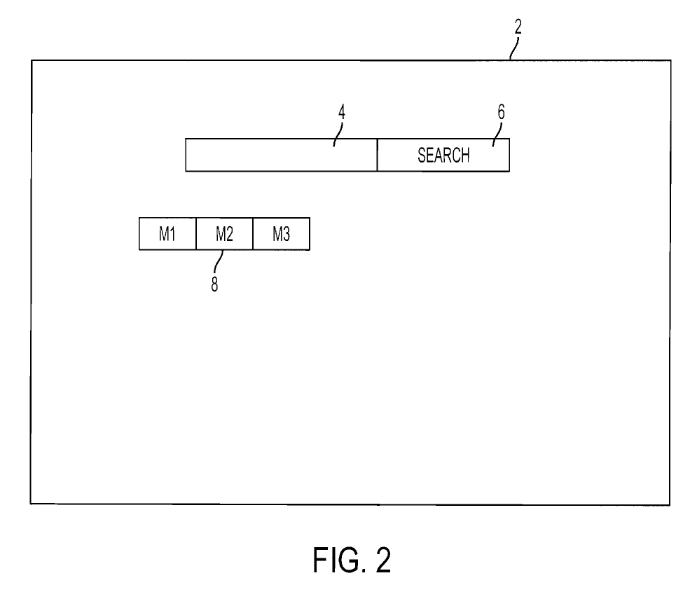

As discussed in the Background section, there is a need to develop new tools and search engines that are more accurate, faster, more reliable and more capable than the existing tools. According to an exemplary embodiment, a domain-query search engine that does not use only keywords to search for desired information is shown in FIG. 2. FIG. 2 shows a screen 2 that is presented to a user. On the screen 2, the user may see an empty box 4, in which the query may be entered. A button 6 provides the search functionality. A more sophisticated search engine according to other exemplary embodiments could be implemented as a graphical user interface or a browser with various buttons M, each button or control object being associated with a different algorithm for calculating the relatedness of domain names based on the user's input(s). Exemplary algorithms are described in detail below. This exemplary domain-query search engine accepts as an input not only keywords but also, or alternatively, a domain name of interest.

For example, as shown in FIG. 2, a user may enter the “Expedia” domain name, e.g., as “www.expedia.com”, as “expedia.com” or simply as “expedia.” Suppose that a user only knows about the Expedia web site as a site for booking an airplane, hotel, car, etc. However, if that user becomes dissatisfied, for example, with the prices quoted by this site, the user might want to search for similar sites that offer similar products or services, but maybe at a better price. Thus, according to an exemplary embodiment, the user searches for similar web sites or companies based on the relatedness of their domain names.

Based on, among other things, the concept that the collective wisdom is the best approach to follow, search engines or other applications according to these exemplary embodiments, calculate, as will be described later, a relatedness score between the input domain name or web site (e.g., “Expedia” in the example above) and other domain names or web sites. This relatedness score can, for example, be calculated based on captured data generated by various users while searching the Internet, for example, data generated in a Domain Name System (DNS) server. The DNS server, which is discussed in more detail later, is capable of storing the IP addresses of the users, the addresses of the user requested web pages, and the relationships between the users and web pages requested by those users. According to exemplary embodiments, those sites having the highest relatedness scores to the domain name(s) entered as input are then returned to the user in any desired format.

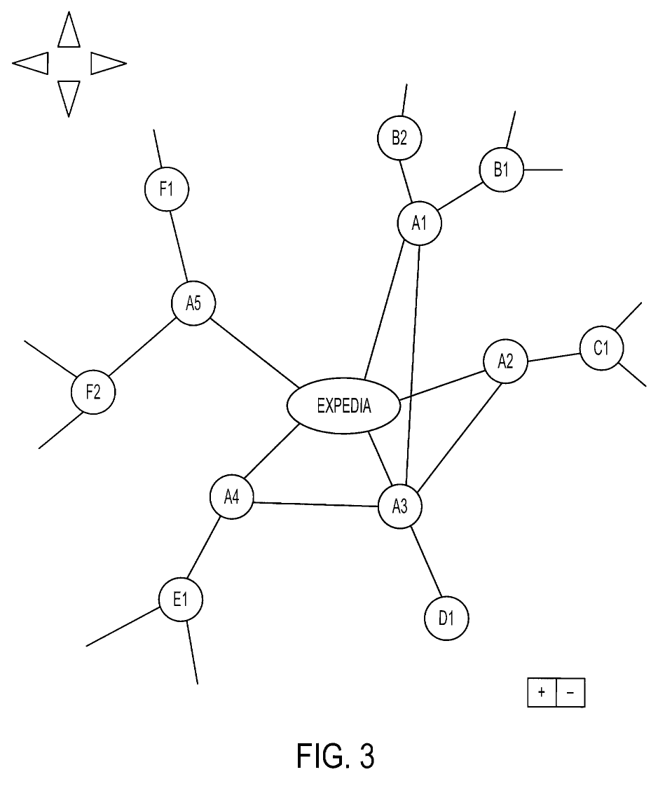

FIG. 3 shows an exemplary display screen or graphical user interface that is provided to the user after the search is performed. This exemplary display of results could, for example, be a final output of results or could also represent an opportunity for the user to refine his or her search. In this display, an icon, text, image or marker representing the site Expedia may be positioned in the center of the figure and the topically related sites, which were identified by the relatedness search algorithm, are displayed around the main site Expedia. Links between the main site Expedia and the newly found (and related) sites may be displayed, for example, as a line that might have a length or thickness which is proportional with that site's relatedness score relative to “Expedia” (not shown). In another exemplary embodiment, the score between Expedia and the related sites is represented by displaying the links in different colors (not shown), e.g., red being highly related, yellow being somewhat related and green being less related than either red or yellow links. Other possibilities to visualize the relatedness score between the Expedia site and related sites may be used, as will be recognized by those skilled in the art.

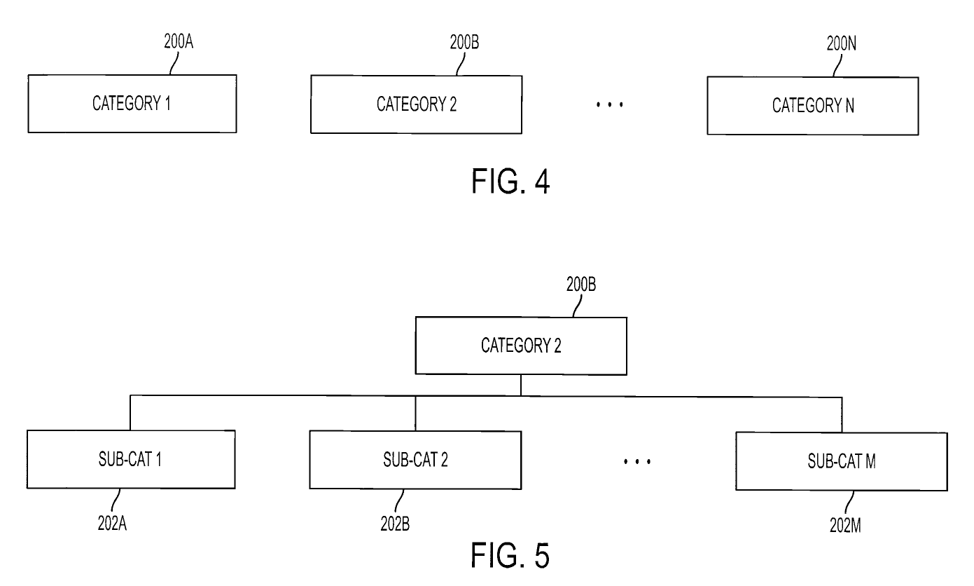

According to another exemplary embodiment, the graphical user interface shown in FIG. 3 may be provided to a user for performing searches without initially providing the screen shown in FIG. 2. In this case, an interface similar to that shown in FIG. 4 may be provided to the user to initiate the search. The interface may display plural (N) categories 200A to 200N from which the user has to select one category. Examples of categories are Movies, Music, Grocery, Auto, etc. Once a category 200B is selected, the user is provided with a new selection screen, see FIG. 5, which may replace or be added to the graphical user interface screen shown in FIG. 4. The user may select a sub-category 202A to 202M of category 200B and so on until the user has sufficiently narrowed the field of search. However, the user may arrive at the interface shown in FIG. 3 directly from the interface shown in any of FIG. 4 or 5. Any desired number of intermediate levels between the interface of FIG. 4 and the interface of FIG. 3 may be provided.

According to another exemplary embodiment, the user may be provided initially with the interface shown in FIG. 3, where instead of the Expedia site shown in the middle of the screen, a default site is shown, for example, Amazon.com. The user could select the default, central site. The user then may follow various links from the default site, e.g., Amazon.com, to arrive at the desired web site(s). For example, the user could point to and click on an object which represents a website that is related to the default site, whereupon the interface would redraw itself with the selected site as the centrally displayed site and having links to its related sites. This process could be repeated as many times as desired to enable the user to “crawl” the Internet from some desired starting website along “paths” which represent relatedness between sites.

FIG. 3 also shows that various buttons or other control objects may be provided in exemplary user interfaces which are used to provide the search results, such objects which enable the user to move to a site identified by the search by using arrows (see arrows in left upper corner of the figure) or using zoom in and out buttons (see buttons in right lower corner of the figure) to display fewer or more search results. Other buttons or control objects that streamline and simplify the navigation may be added, like for example a home button that brings the user to the initial domain name (e.g., Expedia). Alternatively, or additionally, a first button may be provided labeled “Keyword” and a second button labeled “Domain Name”. In such an embodiment, after the user enters an input into the text box on the interface, she or he can press either the “Keyword” button or the “Domain Name” button and the interface will process the search request either as a keyword search, e.g., using a conventional keyword search engine, or as a domain name search, e.g., using the techniques described below. The results can then be output using any of the aforedescribed user interface screens or other output mechanisms.

According to another exemplary embodiment, the user may navigate from one web site to another web site by rolling a cursor over a desired web site, which is displayed on the screen. By moving the cursor over any displayed web site, the graphical interface may, based on the relatedness scores, display the links between the newly selected web site and related web sites. According to an exemplary embodiment, this action may reposition the newly selected web site in the center of the screen and may also move all the other web sites accordingly. Thus, a browsable graph may be generated on the screen as shown, for example, in FIG. 3. According to this exemplary embodiment, the user, after inputting/typing a keyword and/or a domain name, may browse other related web sites by simply using the mouse (or another point and click device) instead of typing more keywords, thus, simplifying the browsing process.

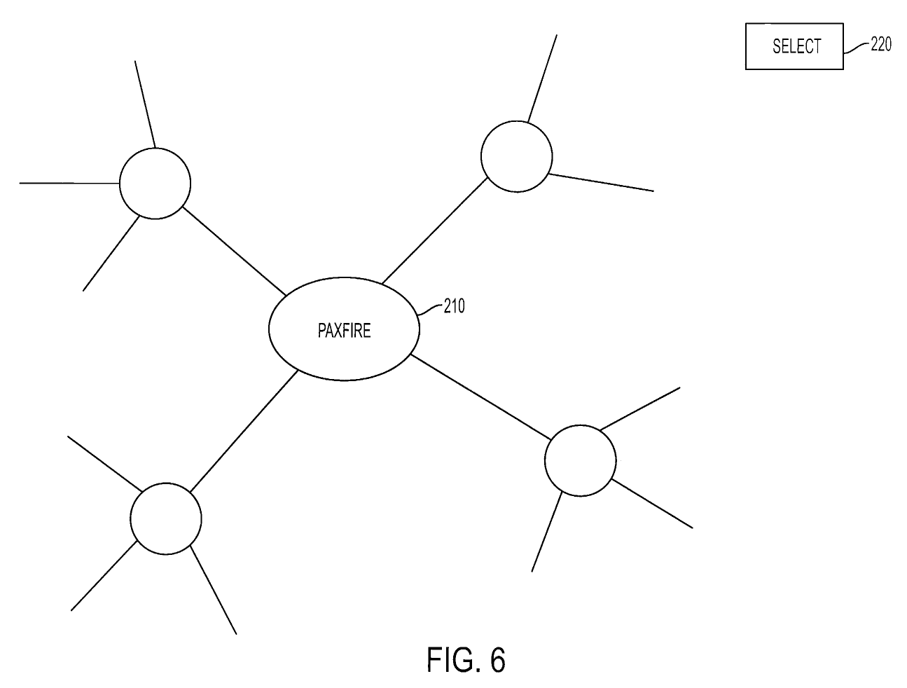

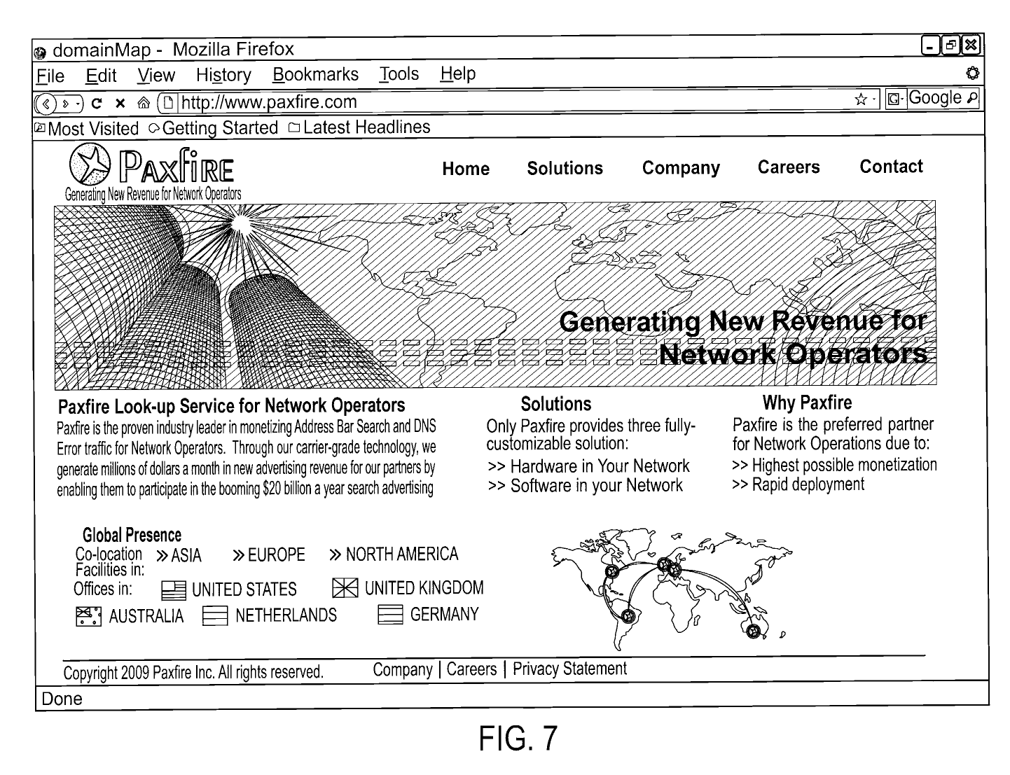

According to another exemplary embodiment, the graphical user interface may present the user with full information available about a selected web site, e.g., the information in the format that a traditional search engine would use to present information based upon a keyword search. More specifically, after the user has arrived at a desired web site 210 (for example Paxfire) as shown in FIG. 6, the user may either roll the mouse over a select button 220 or may right click directly on the icon 210 to display the conventional information available about the Paxfire site, which is shown in FIG. 7. Those skilled in the art would understand that other techniques for selecting the desired web site and displaying the associated information may be used when advancing from the screen shown in FIG. 6 to the screen shown in FIG. 7. In one application, the screen may be split and the content of FIGS. 6 and 7 may be showed simultaneously.

According to another exemplary embodiment, the graphical interface may present the user, when selecting a specific web site, only with those related web sites that are either geographically connected with the selected web site or with those related web sites that are temporally connected to the selected web site. For example, suppose that the user is interested to fix his flat tire and the user knows about a repair shop called FixFlatTire in his or her community. However, the user is not happy with the prices charged by FixFlatTire. Thus, the user may type, e.g., in the input box of the novel browser according to this exemplary embodiment, the domain name “FixFlatTire” and the browser could returns one or more places that may fix a flat tire, e.g., based upon the topical relatedness techniques described below, and which are also located in close geographic proximity to the FixFlatTire or to the location of the user, because the user is interested only in places that are close to his or her location, e.g., house, work place, etc. Close proximity in this sense may be defined in terms of miles or zip codes by the user prior to performing the search, e.g., by entering such information into the user interface prior to clicking the “Search” button or “Domain Name Search” button.

Regarding the temporal approach, suppose that a user intends to watch a movie around 8 pm during a certain day. The user is aware of a movie theater called BestMovie in her community. After the user enters the name of the movie theater, a browser according to these exemplary embodiments may present the user, based on the calculated relatedness scores and the desired time, with other movie theaters that offer a movie around the same time. Thus, the user is presented with a more focused search result than a traditional search engine.

According to another exemplary embodiment, a tool may be developed based on the calculated relatedness scores, and the tool presents a user with “Internet paths” followed by other users after visiting a certain domain name. For example, by knowing that many or most of Internet users that have visit the domain name “Hotels.com” after visiting the domain name “Expedia.com”, e.g., using one or more of the below described topical relatedness techniques, a company that, for certain reasons, wishes to advertise on Expedia, may decide to also advertise on Hotels as many or most of the users would be expected to transit from Expedia to Hotels. Thus, this tool may provide the user with a road map of “highways” that start from an initial domain name and continue to related domain names, such that the user may make an informed decision when selecting which domain names to target for his or her ads.

Other implementations of the relatedness score may be envisioned by those skilled in the art. However, a common component of such implementations is the ability to calculate the relatedness score of various domain names based on the behavior of many users.

How the relatedness score is calculated has been described in patent application Ser. No. ______, filed concurrently herewith, entitled “Probabilistic Association based Method and System for Determining Topical Relatedness of Domain Names” to M. Subotin and A. Sullivan and patent application Ser. No. ______, filed concurrently herewith, entitled “Distribution Similarity based Method and System for Determining Topical Relatedness of Domain Names” to M. Subotin and A. Sullivan, the content of both of which is incorporated herein by reference. For the convenience of the reader, a brief description of how the relatedness scores can be calculated is discussed next.

Data related to client queries from DNS resolvers may be used to determine topical relatedness of various Internet domains with respect to contents of their web pages or other services they may provide to clients. For that purpose, queries from DNS resolvers may be stored in dedicated files (logs) together with the IP address of the client (which may correspond to one or more clients) and the time of the request.

The topical relatedness scores of domains can be estimated using probabilistic methods for measuring statistical association between random variables, called herein “probabilistic association estimates.” These are computed based on occurrence counts for domain names and domain name pairs.

A topical relatedness score between domains d_{A} and d_{B} may be estimated using pointwise mutual information PMI(d_{A},d_{B}), which is defined as:

$$PMI ( {d}_{A} , {d}_{B} ) = ln \frac{p ( {d}_{A} , {d}_{B} )}{p ( {d}_{A} ) \cdot p ( {d}_{B} )} , \qquad ( 1 )$$

where p(d_{A},d_{B}), p(d_{A}) and p(d_{B}) are empirical estimates of the probabilities of co-occurrence of domain name queries d_{A} and d_{B} and their individual occurrence, respectively.

An improved score may be calculated if using the probability-weighted pointwise mutual information (PWPMI):

$$PWPMI ( {d}_{A} , {d}_{B} ) = p ( {d}_{A} , {d}_{B} ) \cdot ln \frac{p ( {d}_{A} , {d}_{B} )}{p ( {d}_{A} ) \cdot p ( {d}_{B} )} \qquad ( 2 )$$

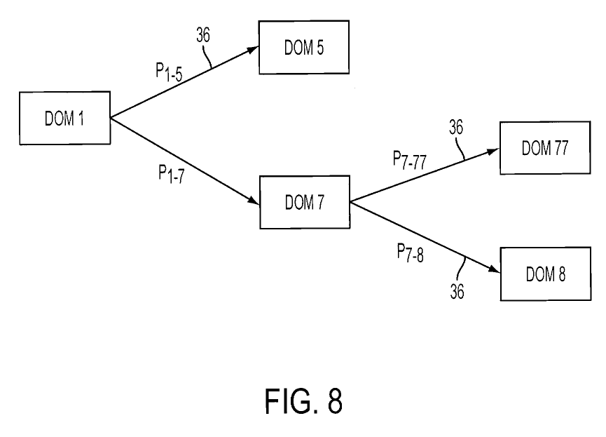

By calculating the “PWPMI” probability for each pair of domains requested by the clients of a certain ISP, a path tree for each domain name may be constructed, as shown in FIG. 8. Each domain name DOMi (dᵢ) is connected to one or more other domain names via a corresponding direct path 36. Each path indicates possible sequences of domain names that are requested by a client. Each path may be associated with a probability (computed, for example, by dividing each relatedness score by the sum of scores associated with all connections between dᵢ and other domains) for traveling or navigating, for example, from domain DOM7 to DOM8. This probability p7-8, may be calculated by using the probability PMI, the more complex and accurate probability PWPMI, or other probabilities or combinations of probabilities. These calculated scores indicate, for example, for a generic user visiting domain DOM7, the most likely next domain to be visited based on the collective wisdom, i.e., the experience of the previous users which has been captured in data as described above. For example, if DOM8 is more likely to be related in terms of relatedness to DOM7 than DOM77, the estimated P₇₋₈ is likely to be higher than the estimated P₇₋₇₇. This is true because most users tend to exhibit similar behavior patterns.

The relatedness score may also be calculated based on the distributional similarity method. A collection of vectors is generated based on the DNS data. The distributional similarity technique assumes that two domains are related if they tend to appear in the same client session. A matrix representation of client sessions is introduced and various mathematical operations are applied to reduce the dimensionality of the original matrix. Dimensionality reduction may be performed by applying a dimensionality reduction method, for example, the truncated singular value decomposition (SVD) method. The resulting k-dimensional vectors that correspond to the rows of the matrix may be used for calculating the relatedness score. Alternatively or in addition, the cosine of the angle between the vectors of the reduced matrix or, equivalently, the dot product of normalized vectors of the matrix may be used to measure the relatedness score between a pair of vectors.

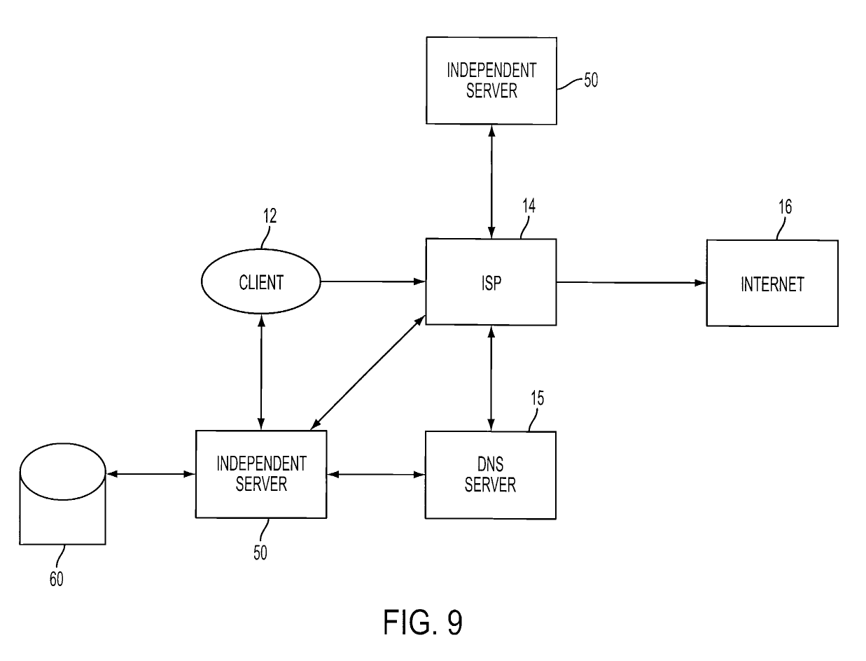

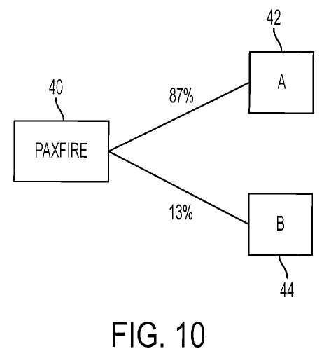

According to an exemplary embodiment, a method for calculating a relatedness score of pairs of domain names requested by clients may be implemented at the ISP 14 provider or at another location outside the ISP, for example, an independent server 50 connected to the ISP 14 as shown in FIG. 9, at the client 12, and/or at the DNS server 15. More specifically, with regard to FIG. 10, assume that the client is visiting the domain named “Paxfire,” which provides specialized solutions for media interfaces. If the user intends to compare the products offered by Paxfire with similar products offered by the competitors but the user does not know who the competitors of Paxfire are, according to an exemplary embodiment the user may perform a domain name search (based on the above described method) instead of a keyword search to find out those domain names that are related to Paxfire.

If the user enters the name Paxfire.com in the search engine shown in FIG. 2, the search engine will communicate with an application located, for example, on the independent server 50 to search a database 60, which stores the relatedness scores for the domain servers. The search on the database 60 identifies the domain names most related to Paxfire.com 40, which happens to be A.com 42 and B.com 44 in this particular example. For this example, it is assumed that Paxfire 40 provides media solutions to the A provider 42 and the degree of association of Paxfire and A.com is 87% while the degree of association of Paxfire.com and B.com (a domain name belonging to a company that produces hardware for set top boxes) is only 13% (see FIG. 10). Thus, the probabilistic association method is able to identify that A.com 42 is more related to Paxfire.com than any other domain name and also to identify other related business establishments, i.e., site B 44.

In response to the query of the user, the independent server 50, based on the already calculated PWPMI of Paxfire and other domain names, provides the user with A and B's domain names (or other information pointing the user toward A and B's domains, e.g., a complete URL or link to a URL associated with the A and B's domains) instead of any other domains, based on the high correlation between Paxfire and A and B.

In addition or alternately, the independent server 50 may provide the user with ads related to the A and/or B domains, i.e., ads associated with the most related domains to Paxfire. Alternatively, the independent server 50 may inform the A or B companies about the type of ad to be provided to the user and the companies then provide the ad to the user. Thus, most of the users that visit Paxfire may be automatically provided with information associated with and/or an identifier of the web site of A and/or B when searching by domain name.

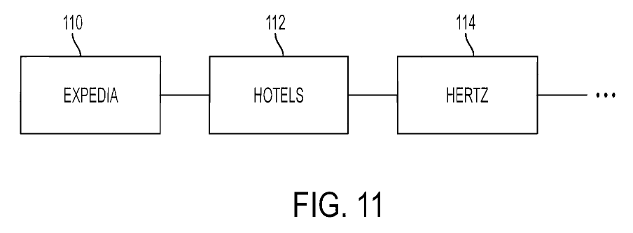

According to another exemplary embodiment, the graphical user interface may be configured to provide, in response to an input domain name from the user, a single path linking the input domain name to a sequence of related domain names as shown in FIG. 11. More specifically, assuming that the user inputs domain name 110, for example, Expedia, the logic of the graphical user interface determines that the most related domain name 112 is Hotels. The same logic of the graphical user interface also determines that the most related domain name 114 of Hotels is Hertz and so on. Based on these determinations, which use, for example, the highest relatedness score between two adjacent domain names in the path shown in FIG. 11, the graphical user interface generates the sequence of domain names shown in FIG. 11. With the graphical user interface configured as discussed in this paragraph, a user may determine plural web sites on which to place his or her ads given the high probability that a consumer will visit sites Expedia, Hotels, and Hertz in this order.

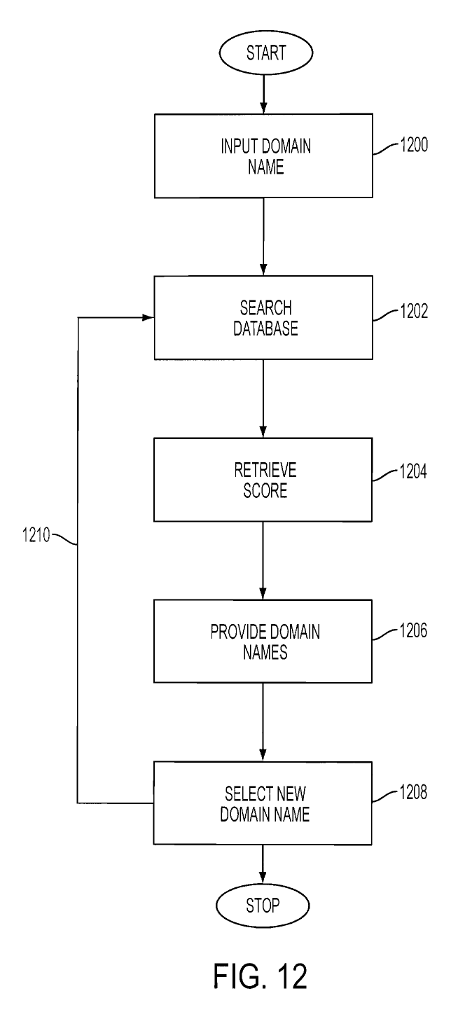

Next, some specific implementations of the exemplary embodiments are discussed in the context of a user interface that may be implemented on a computing device, i.e., a mobile phone, personal computer, laptop, server, personal digital assistant, etc. According to an exemplary embodiment illustrated in FIG. 12, in step 1200 a user may input a domain name, for example, expedia.com, into the user interface. The user interface searches in step 1202 a database (not shown) for identifying the relatedness scores of the input domain name with other domain names. These other domain names that are related to the input domain name are called related domain names. According to an application, the related domain names include those domain names that have relatedness scores with the input domain name which are above a predetermined threshold.

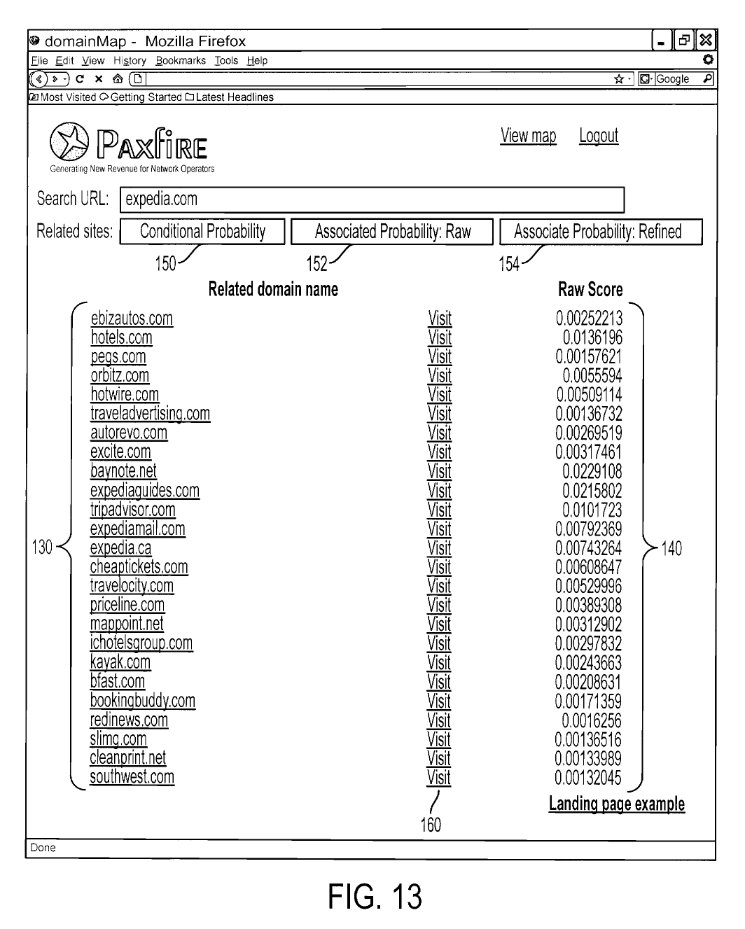

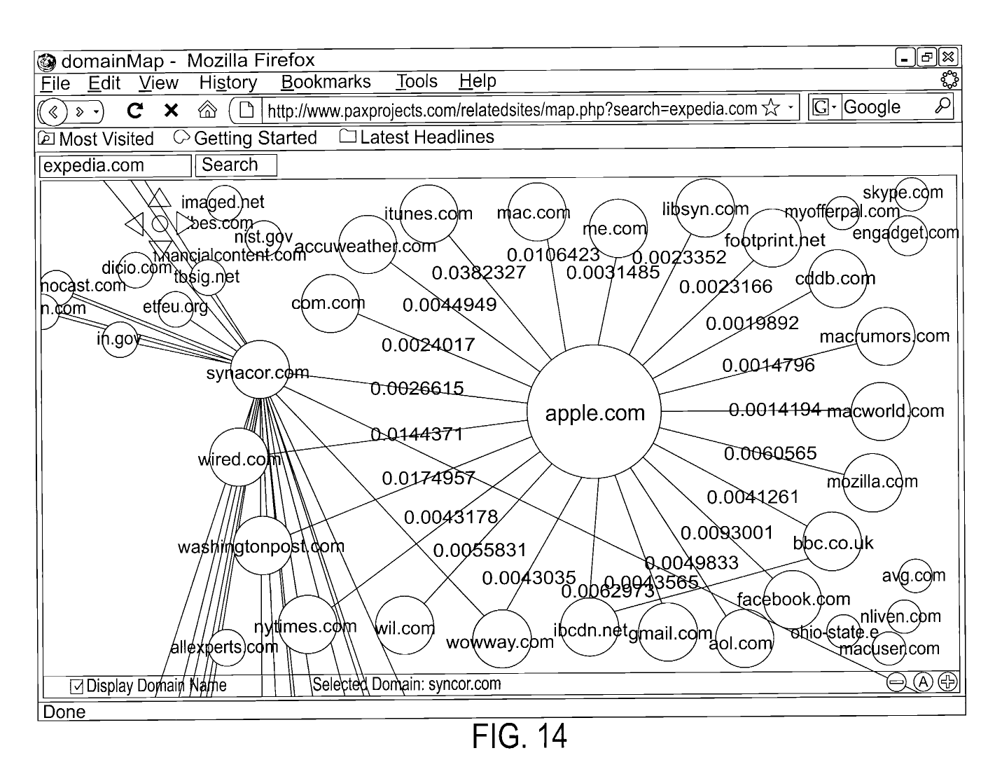

The user interface may retrieve in step 1204 the relatedness scores of the related domain names and may display them in step 1206, either numerically or in any desired manner. Further domain names, related to the related domain names may also be retrieved. Two possible modes for displaying the related and further domain names are shown in FIGS. 13 and 14. Those skilled in the art would recognize that other displaying modes are possible. FIG. 13 shows a list 130 of domain names (the related domain names) related to, for example, Expedia.com, and also the associated relatedness scores 140. However, in one exemplary embodiment the related domain names can be divided into different classes depending on their relatedness scores. These different classes of domain names may be shown at different locations on a display screen, and/or using different colors. The user interface illustrated in FIG. 13 also shows various buttons 150, 152, and 154 that trigger calculations of the relatedness scores based on different methods, as already discussed above. In addition, the user interface may include an interactive button 160, which takes the user, when the user clicks on that button, to a web page associated with the related domain name.

For example, the relatedness of a pair of domain names may be determined by combining scores determined with the probabilistic method with scores determined with other methods, for example, the distribution similarity method. The weights of such scores may be determined such that the final results fit the real relatedness of the considered domain names. A button corresponding to such calculations may be added to the user interface. According to another exemplary embodiment, the scores of several models may be interpolated into a single score equal to a weighted sum, with the weights tuned to maximize DMOZ-based accuracies. A corresponding button may be added to the user interface.

FIG. 14 shows, according to another exemplary embodiment, how the related domain names may be displayed in step 1206 of the method discussed with regard to FIG. 12. The input domain name may be displayed in a central position of the screen, with the related domain names displayed around the central position and additional domain names (if any) can be displayed outwardly around the corresponding related domain names. Other configurations or relationships between the displayed domains can be used and more or fewer domain names (search results) may be displayed depending on the user's preferences.

Once the user moves the cursor above one domain name of the related and/or further domain names, the user interface calculates (in real time in one application) the relatedness scores of the rolled over domain name and other domains to generate new related and/or further domain names. The interface may then be updated to display the connections (links) between the rolled over domain name and these new related and/or further domain names. If the user decides to select the rolled over domain name in step 1208 of FIG. 12, the new domain name (e.g., synacor.com in FIG. 14) is repositioned in the central position of the screen, the new related domain names are displayed around the central position and so on as indicated by step 1210 in FIG. 12.

According to an exemplary embodiment, the user interface may retrieve and display relatedness scores among the related domain names or the further domain names. In addition, the user interface may be configured to switch between searching domain names based on relatedness scores or searching based on a keyword, as a conventional search engine. In one application, a combination of the two methods may be used for searching a desired domain name.

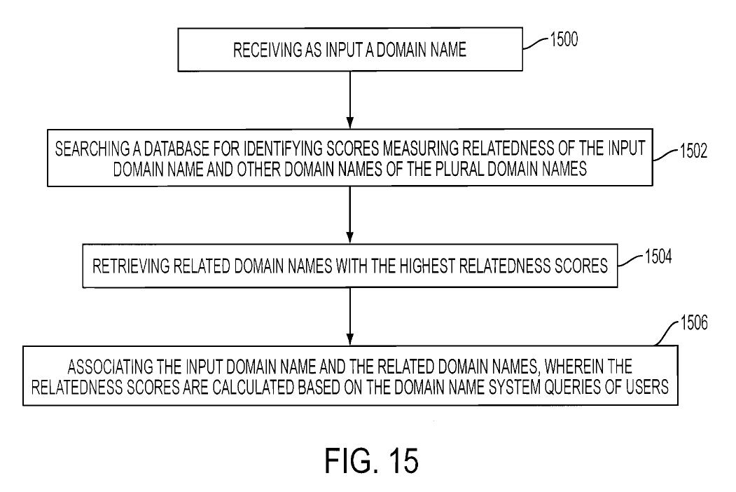

The steps for searching plural domain names based on domain name queries are discussed next with regard to FIG. 15. According to this exemplary embodiment, the method includes a step 1500 of receiving as input a domain name, a step 1502 of searching a database for identifying scores measuring relatedness of the input domain name and other domain names of the plural domain names, a step 1504 of retrieving related domain names with the highest relatedness scores, and a step 1506 of associating the input domain name and the related domain names, wherein the relatedness scores are calculated based on the domain name system queries of users.

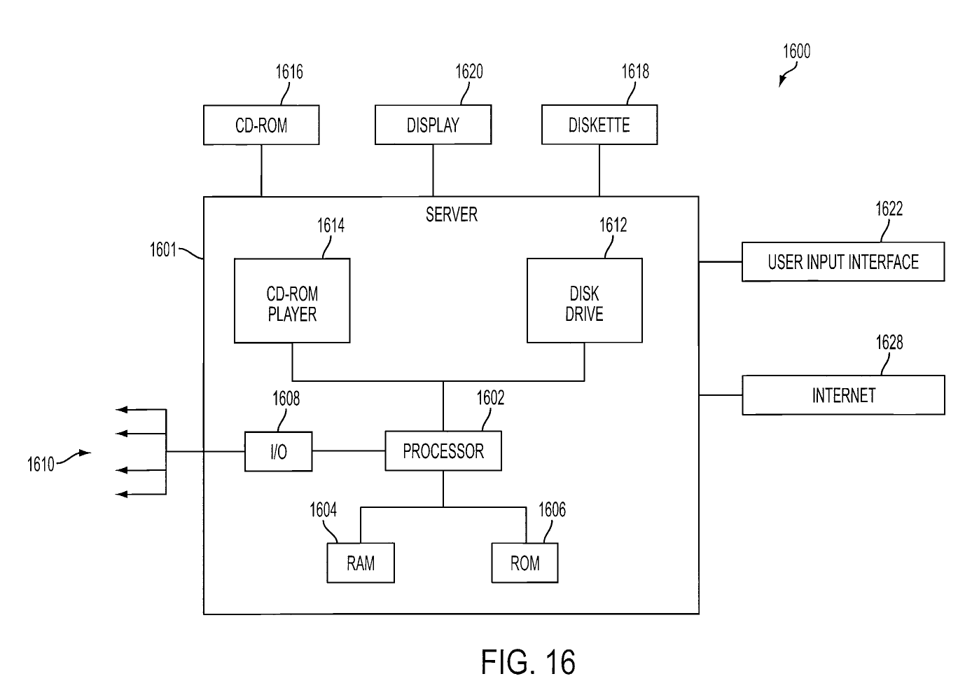

For purposes of illustration and not of limitation, an example of a representative computing system capable of carrying out operations in accordance with the exemplary embodiments is illustrated in FIG. 16. It should be recognized, however, that the principles of the present exemplary embodiments are equally applicable to standard computing systems. Hardware, firmware, software or a combination thereof may be used to perform the various steps and operations described herein.

An exemplary computing arrangement 1600, suitable for performing the activities described in the exemplary embodiments, may include a server 1601 with appropriate configuration and access. Such a server 1601 may include a central processor (CPU) 1602 coupled to a random access memory (RAM) 1604 and to a read-only memory (ROM) 1606. The ROM 1606 may also be implemented as other types of storage media to store programs, such as a programmable ROM (PROM), an erasable PROM (EPROM), etc. The processor 1602 may communicate with other internal and external components through input/output (I/O) circuitry 1608 and bussing 1610, to provide control signals and the like. The processor 1602 carries out a variety of functions as is known in the art, as dictated by software and/or firmware instructions.

The server 1601 may also include one or more data storage devices, including hard and floppy disk drives 1612, CD-ROM drives 1614, and other hardware capable of reading and/or storing information such as DVD, etc. In one embodiment, software for carrying out the above discussed steps may be stored and distributed on a CD-ROM 1616, diskette 1618 or other form of media capable of portably storing information. These storage media may be inserted into, and read by, devices such as the CD-ROM drive 1614, the disk drive 1612, etc. The server 1601 may be coupled to a display 1620, which may be any type of known display or presentation screen, such as LCD displays, plasma display, cathode ray tubes (CRT), etc. A user input interface 1622 is provided, including one or more user interface mechanisms such as a mouse, keyboard, microphone, touch pad, touch screen, voice-recognition system, etc.

The server 1601 may be coupled to other computing devices, such as landline and/or wireless terminals and associated watcher applications, via a network. The server may be part of a larger network configuration as in a global area network (GAN) such as the Internet 1628, which allows ultimate connection to the various landline and/or mobile client devices.

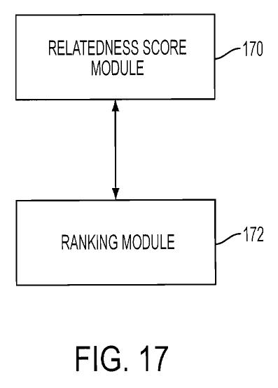

The processor 1602 of the server 1601 may be programmed to generate specific modules for implementing the methods illustrated in FIG. 15. According to an exemplary embodiment shown in FIG. 17, the modules may include a relatedness score module 170 that may be configured to calculate and/or retrieve the relatedness scores for the various domain names and a ranking module 172 that may be configured to present to the user the retrieved domain names in a certain order, for example, ranked based on a value of the relatedness scores as first and second order domain names. These modules may be implemented in software in the processor 1602 shown in FIG. 16.

The disclosed exemplary embodiments provide a server, a method and a computer program product for identifying domain names that are related to each other. It should be understood that this description is not intended to limit the invention. On the contrary, the exemplary embodiments are intended to cover alternatives, modifications and equivalents, which are included in the spirit and scope of the invention as defined by the appended claims. For example, according to exemplary embodiments, a search engine's graphical user interface can provide options for the user input to be considered as a keyword (i.e., perform a traditional keyword search using the input(s)), a domain name (i.e., perform a domain name relatedness search using the input(s)), or both (i.e., perform both a traditional keyword search using the inputs and a domain name relatedness search using the input(s) and combine or select results from both searches to be displayed to the user). Further, in the detailed description of the exemplary embodiments, numerous specific details are set forth in order to provide a comprehensive understanding of the claimed invention. However, one skilled in the art would understand that various embodiments may be practiced without such specific details.

As also will be appreciated by one skilled in the art, the exemplary embodiments may be embodied in a wireless communication device, a telecommunication network, as a method or in a computer program product. Accordingly, the exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer readable medium may be utilized including hard disks, CD-ROMs, digital versatile disc (DVD), optical storage devices, or magnetic storage devices such a floppy disk or magnetic tape. Other non-limiting examples of computer readable media include flash-type memories or other known memories.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a general purpose computer or a processor.

What is claimed is:

1. A method for searching plural domain names based on domain name system queries, the method comprising:
receiving as input a domain name;
searching a database for identifying scores measuring relatedness of the input domain name and other domain names of the plural domain names;
retrieving related domain names with the highest relatedness scores; and
associating the input domain name and the related domain names, wherein the relatedness scores are calculated based on the domain name system queries of users.

2. The method of claim 1, further comprising:
displaying the input domain name in a central position on a screen;
displaying the related domain names around the central position; and
displaying further domain names, having relatedness scores with at least a domain name of the related domain names, around the other domain names.

3. The method of claim 2, further comprising:
retrieving from the database relatedness scores of (i) the related domain names and (ii) the further domain names for establishing connections between the related domain names and the further domain names.

4. The method of claim 2, further comprising:
retrieving from the database relatedness scores among the related domain names; and
displaying connections between the related domain names.

5. The method of claim 1, further comprising:
receiving a user input indicative of one of the displayed domain names;
displaying the one of the displayed domain names in the central position; and
displaying associated related domain names based on corresponding relatedness scores.

6. The method of claim 1, further comprising:
displaying information associated with a displayed domain name when a user selects the displayed domain name, wherein the information includes text and/or pictures.

7. The method of claim 1, further comprising:
switching between (i) searching the plural domain names by a domain name and (ii) searching based on keywords.

8. The method of claim 1, further comprising:
searching the plural domain names based on keywords.

9. The method of claim 1, further comprising:
displaying the relatedness scores between the input domain name and the related domain names as one of numbers, colors, probabilities, line thicknesses, or other geometrical shapes.

10. The method of claim 1, further comprising:
displaying the input domain name and the related domain names as a list with the corresponding highest relatedness scores displayed as numbers next to each domain name of the related domain names.

11. The method of claim 1, further comprising:
calculating the relatedness scores based on at least one of a probabilistic quantity, a scalar product of two vectors, or a combination of the two.

12. The method of claim 1, further comprising:
populating the database with the domain name system queries received from a Domain Name Server.

13. The method of claim 1, further comprising:
receiving a message from a user that is indicative of a time and/or location of the user; and
displaying only related domain names that are within a predetermined time interval of the user and/or a predetermined radius of the location of the user.

14. The method of claim 1, further comprising:
displaying only the input domain name connected to a single domain name of the related domain names, which in turn is connected to a single domain name of further domain names that are related to the related domain names.

15. A computer readable medium including computer executable instructions, wherein the instructions, when executed, implement a method for searching plural domain names based on domain names queries, the method comprising:
providing a system comprising distinct software modules, wherein the distinct software modules comprise a relatedness score module and a ranking module;
receiving as input a domain name;
searching a database for identifying scores measuring relatedness of the input domain name and other domain names of the plural domain names;
retrieving related domain names with the highest relatedness scores; and
associating the input domain name and the related domain names, wherein the relatedness scores are calculated based on the domain name system queries of users.

16. The medium of claim 15, further comprising:
displaying the input domain name in a central position on a screen;
displaying the related domain names around the central position; and
displaying further domain names, having relatedness scores with at least a domain name of the related domain names, around the other domain names.

17. The medium of claim 15, further comprising:
receiving a user input indicative of one of the displayed domain names;
displaying the one of the displayed domain names in the central position; and
displaying associated related domain names based on corresponding relatedness scores.

18. A graphical user interface for searching plural domain names based on domain name system queries, the graphical user interface comprising:
means for receiving, as input, a domain name;
means for searching a database for identifying scores measuring relatedness of the input domain name and other domain names of the plural domain names;
means for retrieving related domain names with the highest relatedness scores; and
means for associating the input domain name and the related domain names, wherein the relatedness scores are calculated based on the domain name system queries of users.

19. The graphical user interface of claim 18, further comprising:
means for displaying the input domain name in a central position on a screen;
means for displaying the related domain names around the central position; and
means for displaying further domain names, having relatedness scores with at least a domain name of the related domain names, around the related domain names.

20. The graphical user interface of claim 18, further comprising:
means for receiving a user input indicative of one of the displayed domain names;
means for displaying the one of the displayed domain names in the central position; and
means for displaying associated related domain names based on corresponding relatedness scores.

21. A computing system for searching plural domain names based on domain names queries, the computing system comprising:
an input/output interface configured to receive as input a domain name; and
a processor connected to the input/output interface and configured to search a database for identifying scores measuring relatedness of the input domain name and other domain names of the plural domain names,
retrieve related domain names with the highest relatedness scores, and
associate the input domain name and the related domain names,
wherein the relatedness scores are calculated based on the domain name system queries of users.

22. The computing system of claim 21, wherein the processor is further configured to:
display the input domain name in a central position on a screen;
display the related domain names around the central position; and
display further domain names, having relatedness scores with at least a domain name of the related domain names, around the other domain names.

23. The computing system of claim 22, wherein the processor is further configured to:
retrieve from the database relatedness scores of (i) the related domain names and (ii) the further domain names for establishing connections between the related domain names and the further domain names.

24. The computing system of claim 22, wherein the processor is further configured to:
retrieve from the database relatedness scores among the related domain names; and
generate, to be displayed, connections between the related domain names.

25. The computing system of claim 21, wherein the processor is further configured to:
receive a user input indicative of one of the displayed domain names;
display the one of the displayed domain names in the central position; and
display associated related domain names based on corresponding relatedness scores.

26. The computing system of claim 21, wherein the processor is further configured to:
generate, to be displayed, information associated with a displayed domain name when a user selects the displayed domain name, wherein the information includes text and/or pictures.

27. The computing system of claim 21, wherein the processor is further configured to:
switch between (i) searching the plural domain names by a domain name and (ii) searching based on keywords.

28. The computing system of claim 21, wherein the processor is further configured to:
search the plural domain names based on keywords.

29. The computing system of claim 21, wherein the processor is further configured to:
display the relatedness scores between the input domain name and the related domain names as one of numbers, colors, probabilities, line thicknesses, or other geometrical shapes.

30. The computing system of claim 21, wherein the processor is further configured to:
display the input domain name and the related domain names as a list with the corresponding relatedness scores displayed as numbers next to each domain name of the related domain names.

31. The computing system of claim 21, wherein the processor is further configured to:
calculate the relatedness scores based on at least one of a probabilistic quantity, a scalar product of two vectors, or a combination of the two.

32. The computing system of claim 21, wherein the processor is further configured to:
populate the database with the domain name system queries received from a Domain Name Server.

33. The computing system of claim 21, wherein the processor is further configured to:
receive a message from a user that is indicative of a time and/or location of the user; and
display only related domain names that are within a predetermined time interval of the user and/or a predetermined radius of the location of the user.

34. The computing system of claim 21, wherein the processor is further configured to:
display only the input domain name connected to a single domain name of the related domain names, which in turn is connected to a single domain name of further domain names.
